(19) United States
(12) Patent Application Publication
(10) Pub. No.: US 2005/0136992 A1
(43) Pub. Date: Jun. 23, 2005

(54) Providing access to auxiliary hardware in multiprocessor devices

(76) Inventor: Peter D. Mueller, Fair Oaks, CA (US)

Correspondence Address: TROP PRUNER & HU, PC, 8554 KATY FREEWAY, SUITE 100, HOUSTON, TX, 77024, US

(21) Appl. No.: 10/744,623

(22) Filed: Dec. 23, 2003

(51) Int. Cl. H04B 1/38

(52) U.S. Cl. 455/574

(57) ABSTRACT

An auxiliary hardware device may be shared between two processors in a mobile device, for example, to reduce power consumption. As one example, the auxiliary hardware device may be a codec. The processors may have an interface to independently access the auxiliary hardware device. As a result, it may be unnecessary to power up both processors to access the shared auxiliary hardware device.

### BACKGROUND

This invention relates generally to multiprocessor mobile devices.

Mobile devices such as cellular telephones and personal digital assistants may have highly evolved processing capabilities. In some cases, separate baseband and application processors are provided. The baseband processor may provide communication capabilities while the application processor may handle a range of other tasks such as providing user interfaces, multimedia application handling, operating systems, and communicating with peripherals. The baseband processor may include radio frequency controls, communication protocols, and provide data and voice processing.

Conventionally, the baseband and application processors communicate over an appropriate interface, such as a peripheral bus or serial interface. Voice processing is normally handled in a chipset coupled to the application processor. As a result, the application processor may be bogged down with elaborate voice processing.

One application for multiprocessor systems of this type is called the Voice Over Internet Protocol (VOIP). VOIP is the transport of voice packets over Internet protocol network. Such systems may use a network processor to implement various communication protocols.

The conversion of analog voice data into digital packets may be handled by an encoder/decoder or codec. However, the interface between the codec and the application processor may have a number of undesirable consequences. During Internet Protocol communications for a VOIP application, there may be little need for the application processor to remain in a powered-up state. Thus, the only activity on the application processor may be sending data to the codec. As a result, the application processor must remain powered up to handle the auxiliary codec hardware.

It would be desirable to reduce the power consumption of mobile or battery powered devices. Because they have limited power supplies, it would be desirable to provide alternate ways of implementing mobile multiprocessor systems that reduces their power consumption.

### BRIEF DESCRIPTION OF THE DRAWINGS

FIG. 1 is a block depiction of one embodiment of the present invention; and

FIG. 2 is a flow chart for software for one embodiment of the present invention.

### DETAILED DESCRIPTION

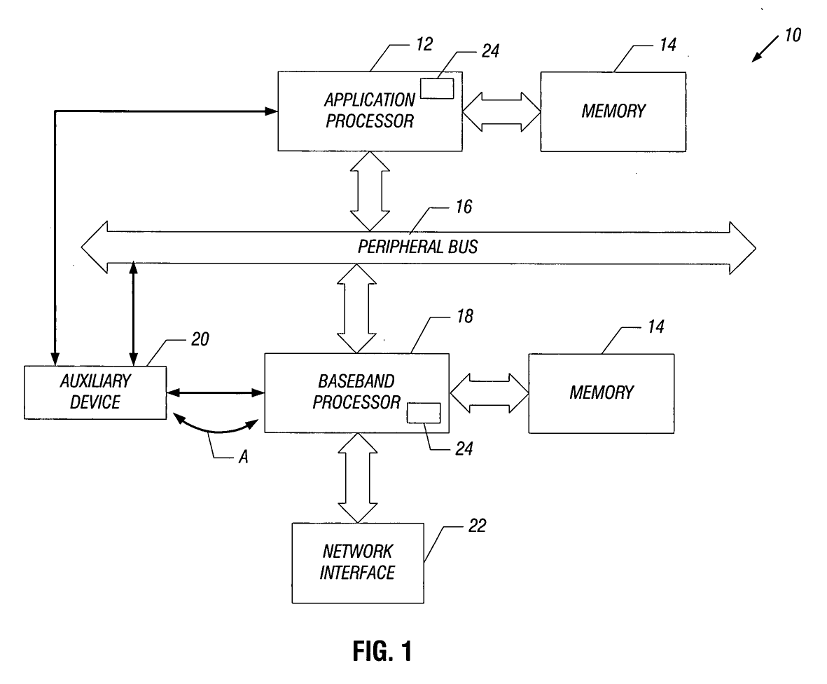

Referring to FIG. 1, a mobile or battery powered multiprocessor system 10 may include an application processor 12 and a baseband processor 18 in one embodiment. By “multiprocessor” it is intended to refer to a system using two separate processors. The processors may be microprocessors, controllers, or digital signal processors. While an example of a system using a baseband and an application processor is given, the present invention is not so limited.

The processors 12 and 18 may communicate through a peripheral bus 16. The peripheral bus 16 may be a conventional bus, or in other embodiments, it may be a physical interface such as a serial link. The processor 12 may communicate with the auxiliary device 20 through another serial interface. The AC '97 link is one example. See Audio Codec '97 Component Specification, v. 2.3, release 1.0, July 2002, available from Intel Corporation, Santa Clara, Calif.

The auxiliary hardware device 20 may have two ports, or use a shared port, so that it may be accessed by both processors 12 and 18. However, instead of requiring the application processor 12 to always interface with the device 20, the baseband processor 18 may also communicate with the device 20 as indicated by the arrow A. This may enable switching of the handling of the device 20 between the processors 12 and 18.

For example, in voice over Internet Protocol (VOIP), conversion of analog voice data to digital packets in a codec may involve a number of machine instruction cycles. In one example, the device 20 may be a codec. As a result, the application processor 12 may be unable to power down to save power, even in those cases where the only function being implemented by the processor 12 is supporting the hardware device 20. The other communication protocols (other than the encoder/decoder function) may be handled by the baseband processor 18. In such case, the application processor 12 would have to remain powered up simply to handle the device 20, which the baseband processor 18 could readily handle itself. If the baseband processor 18 is handling the VOIP operation it would be unable to power down anyway. However, but for the need to handle the codec, the application processor 12 could power down to a lower power consumption state in this example.

Thus, as shown in FIG. 1, a network interface 22 may communicate with a baseband processor 18. The network interface 22 may send or receive packets, such as voice data packets. Those packets may be destined for the baseband processor 18 or may originate from the baseband processor 18 and are intended to go out over a network. However, in either case, a codec operation may be needed to translate the packets to or from an analog format.

In one embodiment, the baseband processor 18 may be a wireless baseband processor. One such wireless baseband processor may be an 802.11 standard processor. See IEEE Std. 802.11-1997, available from IEEE, Inc., New York, N.Y.

The baseband processor 18 may itself access the hardware device 20 which in this example may be a codec. Then data transfer over the network may flow directly between the baseband processor 18 and the hardware device 20 with no involvement required from the application processor 12. A power savings may result in some embodiments because the application processor 12 can power down to a lower power consumption mode. In addition, system traffic may be reduced in some embodiments, which may also reduce power consumption.

Conventionally, packet processing is done by the application processor 12 that reads from the device 20, processes the packets, and then writes them to the memory 14. The device 20 is conventionally a separate device that is shared with the application processor 12. The ability for each processor to access the device 20 may result in significant power savings since the application processor 12 may assume a lower power consumption mode when unneeded to interface with the device 20 and when it has no other active tasks. Additional power savings result from the reduction in multiple data transfers.

Thus, inbound data packets may be transferred from the baseband processor 18 to the memory 14. The processor 18 then reads the data from the memory 14 and performs a decode function. That data is then transferred to the device 20. Similarly, the outbound data is read from the device 20, processed by the processor 18, and then written to the memory 14. Then the data is transferred to the baseband processor 18 to be sent over the network. During this sequence of events, the application processor 12 may be powered down.

By enabling the encoder/decoder processing to be handled through the baseband processor 18, the application processor 12 may be idled, resulting in power consumption savings. That is, the baseband processor 18 may read the data from memory and perform the decode function. Then the data may be transferred to the device 20. Outbound data may be read from the device 20, processed by the baseband processor 18, and then written to a memory associated with the baseband processor 18. That data is then transferred to the baseband processor 18 to be sent out over the network interface 22.

The device 20 may be a subscriber line interface circuit, encoder/decoder in one embodiment of the present invention. Application layer software may handle voice and telephony digital signal processing tasks, such as echo cancellation, compression/decompression, and tone detection in some embodiments.

The memory 14 may be a semiconductor volatile or non-volatile memory in some embodiments. As examples, it may be flash memory, ovonic or phase change memory, polymer memory, electrically eraseable programmable read only memory, static random access memory, or a synchronous dynamic random access memory.

In some embodiments, the device 20 may be a separate device. In other embodiments it may be integrated into one of the processors 12 and 18 or some other component.

Examples of the device 20 may include image data processors, such as graphics accelerators, display controllers, and cameras. The device 20 may also be an encryption/decryption engine as still another example.

As another application in which the device 20 is a codec, a cellular network may be implemented. In such case, the codec may handle streaming audio data.

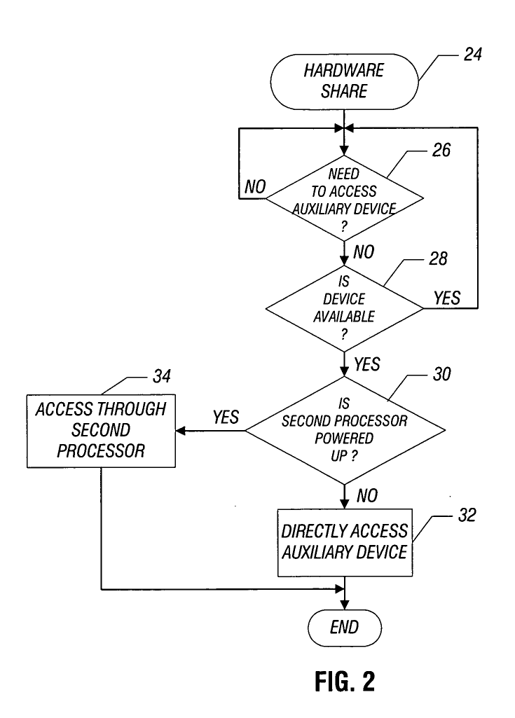

The application processor 12 and the baseband processor 18 may each store the software 24 to implement hardware sharing. The hardware share software 24, shown in FIG. 2, in one embodiment of the present invention may begin by determining whether there is need to access the auxiliary device 20 as indicated at diamond 26. If so, at diamond 28 it is determined whether the auxiliary hardware device 20 is available.

If so, in one embodiment a check at diamond 30 determines whether the other processor is powered up. The other processor, in the case of software running on the baseband processor 18, would be the application processor 12 in the illustrated embodiment and vice versa. If the other processor is not powered up, then the processor running the software 24 directly accesses the auxiliary hardware device 20 itself as indicated in block 32. However, if the other processor is powered up, at least in some cases, the processor running the hardware share software 24 may access the auxiliary hardware device 20 through the other processor as indicated in block 34. However, it may be advantageous for the processor executing the software 24 to handle the device 20 itself, even if the other processor is powered up.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
enabling an auxiliary hardware device to be directly accessed by two processors of a mobile system.

2. The method of claim 1 including enabling at least one processor to determine whether the other processor is powered up.

3. The method of claim 2 including, if the other processor is not powered up, directly accessing the auxiliary hardware device.

4. The method of claim 2 including, if the other processor is powered up, accessing the auxiliary hardware device through the other processor.

5. The method of claim 1 including sharing the auxiliary hardware device between a baseband processor and an application processor.

6. The method of claim 1 including sharing a codec between the two processors.

7. The method of claim 1 including sharing an encryption/decryption engine between two processors.

8. The method of claim 1 including allowing two processors to share a graphics accelerator.

9. The method of claim 1 including allowing two processors to share a display controller.

10. The method of claim 1 including allowing two processors to share a camera.

11. The method of claim 1 including allowing two processors to access said auxiliary hardware device through two separate ports or a single shared port.

12. A system comprising:
a first processor;
a second processor;
an auxiliary hardware device including at least two ports, one port for said first processor and the other port for said second processor; and
a static random access memory.

13. The system of claim 12 wherein said system is a mobile system.

14. The system of claim 12 wherein said system is an embedded system.

15. The system of claim 12 wherein said first processor is an application processor and said second processor is a baseband processor.

16. The system of claim 12 wherein said auxiliary hardware device is a codec.

17. The system of claim 12 wherein said auxiliary hardware device is an encryption/decryption engine.

18. The system of claim 12 wherein said auxiliary hardware device is a display controller.

19. The system of claim 12 wherein said auxiliary hardware device is a camera controller.

20. The system of claim 12 wherein said auxiliary hardware device is a graphics accelerator.

21. The system of claim 12 wherein said system to implement voice over Internet Protocol communications.

22. The system of claim 12 wherein said system to implement cellular communications.

23. An article comprising a medium storing instructions that, if executed, enable a first processor to:
determine whether an auxiliary hardware device is available;
if so, determine whether a second processor is powered up; and
if not, directly access said auxiliary hardware device.

24. The article of claim 23 further storing instructions that, if executed, enable the first processor to access said auxiliary hardware device through said second processor if said second processor is powered up.

25. The article of claim 23 further storing instructions that, if executed, enable the first processor to directly access an auxiliary device in the form of a graphics accelerator.

26. The article of claim, 23 further storing instructions that, if executed, enable the first processor to selectively directly access the auxiliary hardware device or access the auxiliary hardware device through the second processor.

27. The article of claim 23 further storing instructions that, if executed, enable the first processor to implement voice over Internet Protocol.

28. The article of claim 23 further storing instructions that, if executed, enable the first processor to implement cellular communications.

29. A system comprising:
a first processor;
a second processor; and
an auxiliary hardware device including at least two ports, one port for said first processor and the other port for said second processor.

30. The system of claim 29 wherein said first processor is an application processor and said second processor is a baseband processor.

31. The system of claim 29 wherein said auxiliary hardware device is a codec.
